(19) United States
(12) Patent Application Publication
(10) Pub. No.: US 2026/0285344 A1
(43) Pub. Date: Sep. 24, 2026

(54) SAFE AND SECURE END-TO-END AUTONOMOUS DRIVING SYSTEM

(71) Applicant: QUALCOMM Incorporated, San Diego, CA (US)

(72) Inventors: Jean-Philippe MONTEUUIS, Northborough, MA (US); Cong CHEN, San Diego, CA (US); Jonathan PETIT, Wenham, MA (US); Hong CAI, San Diego, CA (US)

(21) Appl. No.: 19/083,111

(22) Filed: Mar. 18, 2025

(51) Int. Cl. B60W 50/14; B60W 50/00; B60W 60/00; G06F 40/186; G10L 13/02

(52) U.S. Cl. CPC B60W 50/14; B60W 60/0015; G06F 40/186; G10L 13/02; B60W 2050/0026; B60W 2050/143; B60W 2050/146

(57) ABSTRACT

Certain aspects of the present disclosure provide techniques and apparatus for autonomous driving. In an example method, sensor data associated with an external environment of a vehicle is obtained. A set of prompts for input to a machine learning model trained to assist with autonomous driving for the vehicle is selected via a manager, based at least in part on the sensor data. A set of output tokens corresponding to the set of prompts is generated using the trained machine learning model and the set of prompts. The set of output tokens is associated with at least one of (i) one or more adversarial objects in the environment or (ii) one or more safety events in the environment. Information associated with the set of output tokens is output via the manager for a user of the vehicle.

### BACKGROUND

### Field of the Disclosure

Certain aspects of the present disclosure generally relate to electronic components, and more particularly to an end-to-end autonomous driving system for a vehicle.

### Description of Related Art

Over the past several years, a vehicle has been transformed from a self-propelled mechanical vehicle into a powerful and complex electro-mechanical system that includes a large number of sensors and processors that control many of the vehicle's functions, features, and operations. The vehicle may be equipped with a vehicle control system, which may be configured to collect and use information from the vehicle's various systems and sensors to automate all or a portion of the vehicle's operations. For example, certain vehicle control systems may include an advanced driver assistance system (ADAS) and/or an autonomous (or automated) driving (AD) system. The ADAS and/or AD system may be configured to automate, adapt, or enhance the vehicle's operations. For example, the ADAS and/or AD system may use information collected from the sensors (e.g., accelerometer, radar, lidar, geospatial positioning, etc.) to automatically detect a potential road hazard, and assume control over all or a portion of the vehicle's operations (e.g., braking, steering, etc.) to avoid detected hazards. Features and functions commonly associated with an ADAS and/or AD system include adaptive cruise control, automated lane detection, lane departure warning, automated steering, automated braking, and automated collision avoidance. The vehicle monitors for errors associated with the control system, and the vehicle may notify an operator of such errors, shut down certain systems, or operate in a degraded state in response to detecting certain errors.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide a processor-implemented method for autonomous driving. The processor-implemented method includes obtaining sensor data associated with an external environment of a vehicle. The processor-implemented method also includes selecting, via a manager, a set of prompts for input to a machine learning model trained to assist with autonomous driving for the vehicle, based at least in part on the sensor data. The processor-implemented method also includes generating, using the trained machine learning model and the set of prompts, a set of output tokens corresponding to the set of prompts. The set of output tokens is associated with at least one of (i) one or more adversarial objects in the environment or (ii) one or more safety events in the environment. The processor-implemented method further includes outputting, via the manager, information associated with the set of output tokens for a user of the vehicle.

Certain aspects of the present disclosure provide a processing system for autonomous driving. The processing system includes one or more memories comprising processor-executable instructions and one or more processors coupled to the one or more memories. The one or more processors are configured to execute the processor-executable instructions and cause the processing system to: obtain sensor data associated with an external environment of a vehicle; select, via a manager, a set of prompts for input to a machine learning model trained to assist with autonomous driving for the vehicle, based at least in part on the sensor data; generate, using the trained machine learning model and the set of prompts, a set of output tokens corresponding to the set of prompts, the set of output tokens being associated with at least one of (i) one or more adversarial objects in the environment or (ii) one or more safety events in the environment; and output, via the manager, information associated with the set of output tokens for a user of the vehicle.

Certain aspects of the present disclosure provide a processing system for autonomous driving. The processing system includes means for obtaining sensor data associated with an external environment of a vehicle. The processing system also includes means for selecting, via a manager, a set of prompts for input to a machine learning model trained to assist with autonomous driving for the vehicle, based at least in part on the sensor data. The processing system also includes means for generating, using the trained machine learning model and the set of prompts, a set of output tokens corresponding to the set of prompts. The set of output tokens is associated with at least one of (i) one or more adversarial objects in the environment or (ii) one or more safety events in the environment. The processing system further includes means for outputting, via the manager, information associated with the set of output tokens for a user of the vehicle.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example vehicle with a vehicle control system, in which aspects of the present disclosure may be practiced.

FIG. 2 is a block diagram of example components and interconnections in a system-on-a-chip (SoC), in which aspects of the present disclosure may be practiced.

FIG. 3 is a block diagram of an example safe and secure end-to-end autonomous driving system, in accordance with certain aspects of the present disclosure.

FIG. 4 depicts an example method performed at a safe and secure end-to-end autonomous driving system, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to a safe and secure end-to-end autonomous driving system for a vehicle.

Certain vehicles come with multiple features for safety, navigation, entertainment, etc., such as an advanced driver assistance system (ADAS) and/or autonomous driving (also referred to as automated driving) (AD), as illustrative examples. As the automotive industry continues transitioning to AD vehicles, there has been increased focus in using end-to-end AD models to realize full AD (often referred to as level 5 (full driving automation), as defined by the Society of Automotive Engineers (SAE)). A vehicle equipped with a full AD system can drive itself (e.g., perform driving actions such as steering, accelerating, and braking) without human input, human attention, and/or human intervention.

Certain end-to-end AD models can realize full AD by generating vehicle driving control signals for various driving actions, such as steering, accelerating, and braking, as illustrative examples, directly from sensor data. Many end-to-end AD models are based on machine learning models, such as deep neural networks, large language models (LLMs), large vision models (LVMs), large multimodal models (LMMs), among others. In one illustrative example, a large language, end-to-end, multimodal AD model (LL-E2E-MM4AD) may have a variety of AD capabilities, such as spatial reasoning (e.g., the ability to visualize and understand objects in multiple dimensions, such as understanding how far apart objects are from each other), road comprehension (e.g., the ability to understand and interpret road signs, traffic signals, and traffic rules), and scene understanding (e.g., the ability to identify objects as well as understand the objects' relationships and contexts within a scene, such as whether an object is consistent with traffic rules), among other capabilities. Certain LL-E2E-MM4ADs can handle input data in one or more (or a combination of) modalities and perform a variety of tasks. The modalities may include visual data (e.g., images, videos, graphical representations), textual (or text) data, sensor data (e.g., light detection and ranging (lidar) data, global positioning system (GPS) data, radar data, ultrasonic data, etc.), auditory data (e.g., speech, ambient sounds, music, etc.), and/or haptic data, among other data types. The tasks may include object detection and tracking (e.g., pedestrians, other vehicles, road obstacles, etc.), mapping, motion prediction, occupancy prediction, and planning, as illustrative examples.

However, while end-to-end AD models are typically tailored for full AD, such end-to-end AD models may not be optimal (or at least suitable) for semi-AD (or partial AD), which may include any of level 4 (high automation), level 3 (conditional automation), level 2 (partial automation), or level 1 (driver assistance), as defined by the SAE. Compared to full AD, semi-AD may involve at least some human input, human attention, and/or human intervention in certain scenarios (e.g., certain vehicle operating conditions, road conditions, and/or environments). In particular, certain end-to-end AD models (e.g., LL-E2E-MM4ADs) may lack compliance with certain functional safety (FuSa) standards/specifications/regulations, such as the FuSa standard provided by the International Organization for Standardization (ISO)/Publicly Available Specification (PAS) 8800-Road vehicles-Safety and Artificial Intelligence).

For example, certain end-to-end AD models may not allow (or support) human interaction when driving. For instance, a LL-E2E-MM4AD in conventional AD systems may not allow a human user to interact with the model, e.g., to override the model's actions, make decisions for the model, visualize events/objects seen by the model, among other interactions. Restricting human interaction, however, can be problematic in a semi-AD system that employs an end-to-end AD model and compromise safety of the driver and others because the driver is generally still responsible for the vehicle's driving actions. Additionally, restricting human interaction in a full-AD system that employs an end-to-end AD model can impact the performance of the end-to-end AD model, since it may not be possible to update the model based on real-time human feedback from a human user in the vehicle, interact with the model regarding the model's decisions, etc.

Additionally, certain end-to-end AD models may lack the capability to communicate with a human user (e.g., driver and/or passenger) regarding security events and/or safety events in the environment. For instance, a LL-E2E-MM4AD in conventional AD systems may not (via prompts and answers) monitor security and/or safety events and interact with a human user regarding the security and/or safety events. With such models, it may not be possible for a human user to (i) be aware of the security and/or safety risks seen by the model, (ii) request the model to indicate safety and/or security events via prompts, and/or (iii) ask the model about certain security events in a periodic or discrete manner.

Certain aspects described herein provide a safe and secure end-to-end AD system that includes a safe and secure end-to-end AD model (e.g., a safe and secure LL-E2E-MM4AD), which can be utilized in vehicles that include semi-AD systems (e.g., SAE levels 4 to 1) and/or full AD systems (e.g., SAE level 5). In certain aspects, the safe and secure end-to-end AD system described herein may include components (hardware and/or software) that can detect safety and/or security events that occur while driving. Additionally, in certain aspects, the safe and secure end-to-end AD system described herein can provide indications of safety and security events to a human user (e.g., driver and/or passenger) (via audio, images, haptics, among other modalities) in order to improve human awareness of the safety and security events. Additionally or alternatively, in certain aspects, the safe and secure end-to-end AD system described herein can allow for real-time human input or feedback regarding safety and security events and use the feedback to update the model.

### Example Vehicle Control System

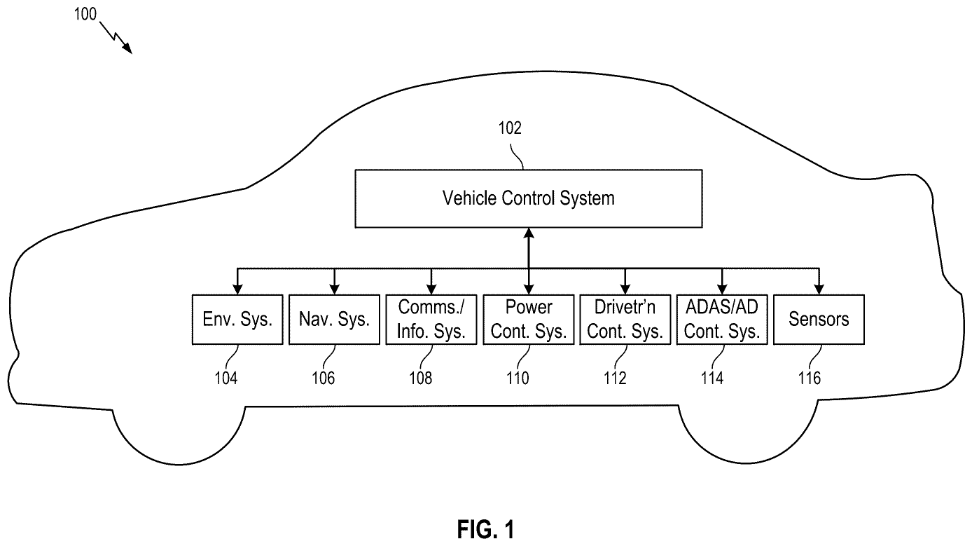

FIG. 1 is a block diagram of an example vehicle 100 including a vehicle control system 102 and various sensors suitable for controlling certain systems, such as an advanced driver assistance system (ADAS), autonomous (or automated) driving (AD), and/or in-vehicle infotainment (IVI). The vehicle 100 may refer to a means of carrying or transporting something (e.g., a person and/or cargo). In some aspects, the vehicle 100 may represent a motor vehicle, such as a car, van, truck, semi-trailer truck, motorcycle, motorbike, moped, electric bicycle, etc. The vehicle 100 may be a series production road vehicle having safety-related systems that include one or more electrical and/or electronic systems, as further described herein. The vehicle 100 may use an internal combustion engine, an electric motor, or a hybrid propulsion system (e.g., a combination of an engine and an electric motor) for propulsion. In some cases, the vehicle 100 may have one or more electrical and/or electronic systems that comply with certain functional safety standards, such as ISO 26262.

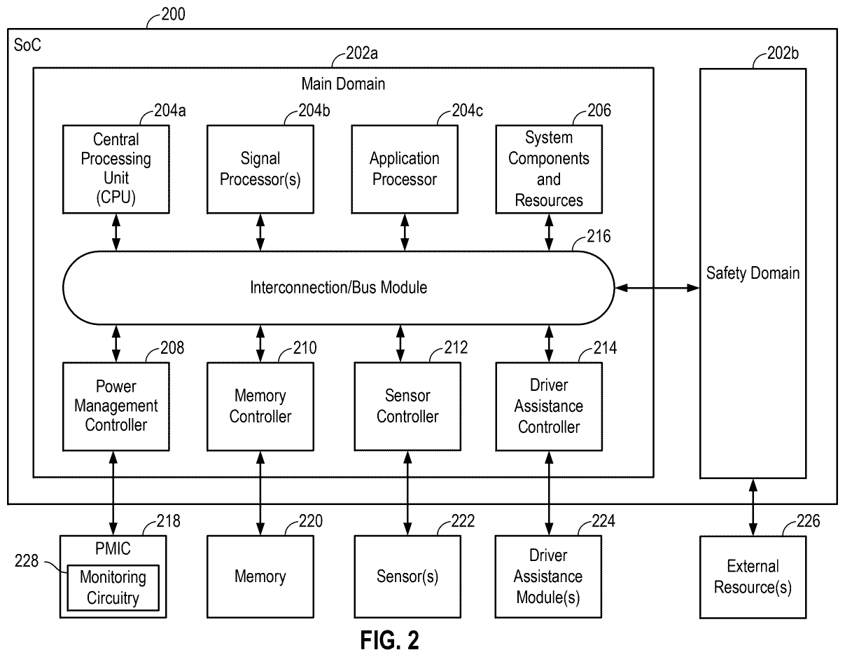

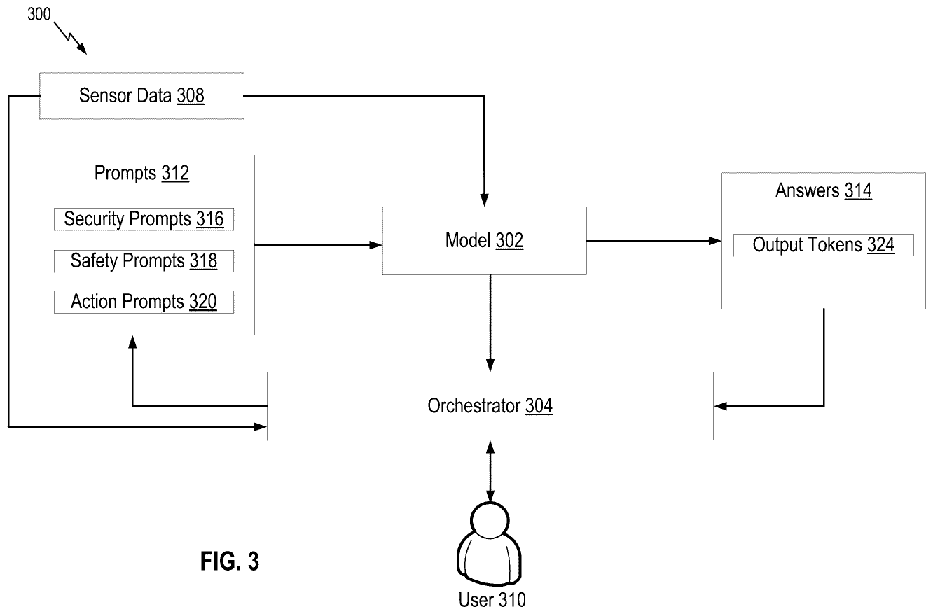

The vehicle 100 may include a vehicle control system 102, which may include one or more computing devices having system-on-a-chips (SoCs) (e.g., one or more electronic control units (ECUs)) as further described herein with respect to FIGS. 2 and 3. The vehicle control system 102 may be coupled to a variety of vehicle systems and subsystems, such as an environmental system 104 (e.g., an air conditioning and/or heating system), a navigation system 106, a communications and/or infotainment system 108, a power control system 110, a drivetrain control system 112, a driver assistance and/or automated driving control system 114, and/or a variety of sensors 116. Each vehicle system or subsystem may communicate with one or more other systems (and/or subsystem(s)) via one or more communication links, which may include wired communication links (e.g., a Controller Area Network (CAN) protocol compliant bus, Universal Serial Bus (USB) connection, Ethernet connection, universal asynchronous receiver-transmitter (UART), etc.) and/or wireless communication links (e.g., a Wi-Fi® link, Bluetooth® link, ZigBee® link, ANT+® link, etc.).

The vehicle control system 102 may perform certain operations associated with any of the vehicle systems and subsystems. For example, the vehicle control system 102 may control or initiate the power-on and/or shutdown sequence for any of the vehicle systems and subsystems. The vehicle control system 102 may monitor for errors associated with any of the vehicle systems and subsystems, and in some cases, the vehicle control system 102 may store the errors for vehicle diagnostics. In response to any errors detected, the vehicle control system 102 may perform certain actions, such as shutting down the affected system or transferring some of the affected operations to be performed at a different vehicle system. The vehicle control system 102 may monitor the power levels supplied to any of the vehicle systems and subsystems and ensure that the power levels supplied satisfy the operating specifications for any of the vehicle systems and subsystems.

The environmental system 104 may control the cooling and/or heating systems associated with the vehicle 100. For example, the vehicle 100 may have an air conditioning system, a heating system, heated or cooled seat(s), and/or a heated steering wheel, and the environmental system 104 may adjust the temperature according to user (or default) settings for the respective cooling and/or heating components. The navigation system 106 may show the vehicle's location on a map and provide navigation information, such as directions to a destination, via a display and/or a speaker (neither shown).

The communications and/or infotainment system 108 may allow the user to access various information (e.g., navigation information, interior or exterior environmental information, ADAS information, etc.), applications, and/or entertainment or media content, such as music and/or videos. The communications and/or infotainment system 108 may allow the user to update or access settings associated with a variety of systems, such as the environmental system 104, the navigation system 106, ADAS, vehicle settings, etc. The communications and/or infotainment system 108 may allow the user and/or vehicle 100 to wirelessly communicate via an integrated modem of the vehicle or via the user's wireless communication device (e.g., a smartphone or tablet).

The power control system 110 may control the components that output power to move the vehicle, such as an internal combustion engine (e.g., adjusting the air-fuel ratio, boost pressure, valve timing, etc.), an electric power system (e.g., controlling regenerative braking, battery power output, battery charging, battery cooling, etc.), and/or a hybrid power system (e.g., controlling regenerative braking, switching between battery power and engine power, battery charging, battery cooling, etc.). The drivetrain control system 112 may control the various components of the vehicle 100 that deliver power to the drive wheels. For example, the drivetrain control system 112 may control gear shifting in an automatic transmission. For a four-wheel drive vehicle, the drivetrain control system 112 may control the power ratio applied to the front and rear drive wheels.

The driver assistance and/or automated driving control system 114 may control various driver assistance features and functions, such as adaptive cruise control, automated lane detection, lane departure warning, automated steering, automated braking, and automated collision avoidance. The driver assistance and/or automated driving control system 114 may control automated driving at various levels of automation, such as any of the SAE levels 1 through 5.

The variety of sensors 116 coupled to the vehicle control system 102 may include a speedometer, a wheel speed sensor, a torquemeter, a turbine speed sensor, a variable reluctance sensor, a sonar system, a radar system, an air-fuel ratio meter, a water-in-fuel sensor, an oxygen sensor, a crankshaft position sensor, a curb feeler, a temperature sensor, a Hall effect sensor, a manifold absolute pressure sensor, various fluid sensors (e.g., engine coolant sensor, transmission fluid sensor, etc.), a tire-pressure monitoring sensor, a mass airflow sensor, a speed sensor, a blind spot monitoring sensor, a parking sensor, cameras, microphones, accelerometers, compasses, a global navigation satellite system (GNSS) receiver (e.g., a GPS receiver or a Galileo receiver), and other similar sensors for monitoring physical or environmental conditions in and around the vehicle.

The aforementioned systems are presented merely as examples, and vehicles may include one or more additional systems that are not illustrated for clarity. Additional systems may include systems related to additional other functions of the vehicular system, including instrumentation, airbags, cruise control, other engine systems, stability control parking systems, tire pressure monitoring, antilock braking, active suspension, battery level and/or management, and a variety of other systems.

### Example System-on-a-Chip

As used herein, the term “system-on-a-chip” (SoC) generally refers to an integrated electronic device comprising one or more integrated circuit (IC) dies (e.g., chiplets), which combines multiple electronic components (e.g., processors and/or memory) on a single substrate or in a single package. A single SoC may contain circuitry for digital, analog, mixed-signal, and/or radio-frequency functions. A single SoC may also include any number of general purpose and/or specialized processors (digital signal processors, modem processors, video processors, etc.), memory blocks (e.g., ROM, RAM, DRAM, flash, etc.), and resources (e.g., timers, voltage regulators, oscillators, etc.). A SoC may also include software for controlling the integrated resources and processors, as well as for controlling peripheral devices.

FIG. 2 is a block diagram of example components and interconnections in a SoC 200 suitable for implementing various aspects of the present disclosure. The SoC 200 may include multiple processing domains having, for example, at least one main domain 202a and at least one safety domain 202b (also referred to as a “safety island (SAIL)”). In the case of multiple main (or safety) domains, the main (or safety) domains may be similar to one another. For ease of description and illustration, the remainder of the disclosure may refer to a main domain 202a and a safety domain 202b, but the reader is to understand that there may be more than one main domain and/or more than one safety domain.

The main domain 202a may be configured to support (or be capable of performing) vehicle operations (e.g., driver assistance and/or automated driving operations, features, etc.) up to a specific automotive safety integrity level (ASIL), and the safety domain 202b may be configured to support (or be capable of performing) vehicle operations up to a lower, the same, or a higher ASIL than the main domain 202a. For example, the main domain 202a may be configured to support (or be capable of performing) vehicle operations up to an ASIL B, and the safety domain 202b may be configured to support vehicle operations up to an ASIL D. In some cases, the main domain 202a may be configured to support (or be capable of performing) vehicle operations up to an ASIL A, B, C, or D, and the safety domain 202b may be configured to support vehicle operations up to a different ASIL than the main domain 202a. In certain cases, the main domain 202a and the safety domain 202b may be configured to support (or be capable of performing) vehicle operations at the same ASIL (e.g., ASIL D). The main domain 202a and the safety domain 202b may be configured to support (or be capable of performing) vehicle operations at different ASILs.

The ASILs may be defined in a specific safety standard, such as ISO 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures.

In certain aspects, the SoC 200 may be included in a computing device (e.g., an ECU) in a vehicle control system. The SoC 200 may control any of the systems described herein with respect FIG. 1. For example, the SoC 200 may be configured to control an ADAS/AD system, such as the driver assistance and/or automated driving control system 114 described herein with respect to FIG. 1. In certain aspects, the SoC 200 may be in communication with other ECU(s) in a vehicle control system, and the SoC 200 and/or a power management integrated circuit (PMIC) 218 may report errors associated with the SoC 200 to the other ECU(s). For example, the main domain 202a may control the environmental system, the infotainment system, and driver assistance features up to a certain ASIL, and the safety domain 202b may control driver assistance features up to a certain ASIL, which may typically be higher than the main domain 202a.

The main domain 202a and/or safety domain 202b may include a number of heterogeneous processors 204a-c (collectively referred to herein as “processors 204”), such as a central processing unit (CPU) 204a, signal processor(s) 204b (e.g., a digital signal processor, an image signal processor, a neural network signal processor, etc.), and/or an application processor 204c. Each processor 204 may include one or more cores, and each processor/core may perform operations independent of the other processors/cores. Each processor 204 may be part of a subsystem (not shown) including one or more processors, caches, etc. configured to handle certain types of tasks or computations. It should be noted that the main domain 202a and/or safety domain 202b may include additional processors (not shown) or may include fewer processors (not shown). The main domain 202a and/or safety domain 202b may include other processors (e.g., a graphics processing unit (GPU), a vision processing unit, etc.) in addition to or instead of those illustrated.

The main domain 202a and/or safety domain 202b may include system components and resources 206 for performing certain specialized operations, such as analog-to-digital conversions and/or wireless data transmissions. The system components and resources 206 may include components such as voltage regulators, oscillators, phase-locked loops (PLLs), modems, peripheral bridges, data controllers, system controllers, access ports, timers, and other similar components used to support the processors and software clients running on the SoC 200. The system components and resources 206 may include circuitry for interfacing with peripheral devices, such as cameras, electronic displays, wireless communication devices, external memory chips, etc.

The main domain 202a and/or safety domain 202b may further include a power management controller 208, a memory controller 210 (e.g., a dynamic random access memory (DRAM) memory controller and/or a non-volatile memory controller), a sensor controller 212, and/or a driver assistance controller 214. The main domain 202a and/or safety domain 202b may also include an input/output (IO) module (not shown) for communicating with resources external to the SoC, such as a clock and a voltage regulator, each of which may be shared by two or more of the internal SoC components. The IO module may include a general purpose IO (GPIO) interface, for example. In certain aspects, each of the main domain 202a and the safety domain 202b may have a separate clock and power supply to facilitate independent operability.

The processors 204 of the main domain 202a may be interconnected to the system components and resources 206, the power management controller 208, the memory controller 210, the sensor controller 212, the driver assistance controller 214, other system components, and/or the safety domain 202b via an interconnection/bus module 216, which may include an array of reconfigurable logic gates and/or implement a bus architecture (e.g., CoreConnect, advanced microcontroller bus architecture (AMBA), etc.). Communications may be provided by advanced interconnects, such as high performance networks-on-chip (NoCs).

The interconnection/bus module 216 may include or provide a bus mastering system configured to grant SoC components (e.g., processors, peripherals, etc.) exclusive control of the bus (e.g., to transfer data) for a set duration, number of operations, number of bytes, etc. In certain aspects, the interconnection/bus module 216 may include a direct memory access (DMA) controller (not shown) that enables components connected to the interconnection/bus module 216 to operate as a master component and initiate memory transactions. The interconnection/bus module 216 may implement an arbitration scheme to prevent multiple master components from attempting to drive the bus simultaneously.

The power management controller 208 may manage the power supplied to the main domain 202a from a PMIC 218, which may be representative of one or more PMIC(s). In some cases, the power management controller 208 may report errors associated with the main domain 202a and/or safety domain 202b to the PMIC 218, as further described herein. The power management and error monitoring control may be separate and independent between the main domain 202a and the safety domain 202b.

The memory controller 210 may be a specialized hardware module configured to manage the flow of data to and from a memory 220. The memory controller 210 may include logic for interfacing with the memory 220, such as selecting a row and column in a cell array of the memory 220 corresponding to a memory location, reading or writing data to the memory location, etc. The memory 220 may be an on-chip component (e.g., on the substrate, die, integrated chip, etc.) of the SoC 200, or alternatively (as shown) an off-chip component.

The sensor controller 212 may manage the sensor data received from various sensors 222, such as the sensors 116. The sensor controller 212 may include circuitry for interfacing with the sensors 222. For example, the sensor controller 212 may receive sensor data from a tire pressure monitoring system and/or a radar sensor used for adaptive cruise control.

The driver assistance controller 214 may control certain driver assistance functions via a driver assistance module 224 (e.g., one or more actuators, relays, switches, etc.). For example, the driver assistance controller 214 may control the adaptive cruise control by controlling actuators coupled to the engine and/or braking system. In some cases, the driver assistance controller 214 may perform automated steering by controlling actuators attached to the steering system. It will be appreciated that the driver assistance controller 214 is merely an example, and the main domain 202a and/or the safety domain 202b may include a controller that interfaces with automated driving components in addition to or instead of the driver assistance controller 214.

The SoC 200 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, temperature, etc.), cameras, compasses, GPS receivers, communications circuitry (e.g., Bluetooth®, wireless local area network (WLAN), Long Term Evolution (LTE), Fifth Generation New Radio (5G NR), etc.), and other well-known components (e.g., accelerometer, etc.) of modern electronic devices.

Each of the processing domains may operate independently of the other domains. In some cases, each of the processing domains may be coupled to separate and independent external resources, such as a PMIC, memory, sensor(s), and driver assistance module(s). A particular external resource may be designed in accordance with an ASIL corresponding to the particular ASIL associated with the main domain 202a and/or the safety domain 202b to which the external resource is coupled. For example, the PMIC 218 may have the same ASIL as the main domain 202a, and the PMIC that provides power to the safety domain 202b may have the same ASIL as the safety domain 202b. The safety domain 202b may include the same or different processing resources and components as the main domain 202a as described herein with respect to the main domain 202a. For example, the safety domain 202b may include the processors 204, the system components and resources 206, the power management controller 208, the memory controller 210, the sensor controller 212, and the driver assistance controller 214. The safety domain 202b may be coupled to certain external resource(s) 226, which may be representative of a PMIC, memory, sensors, and/or driver assistance module, for example, as described herein with respect to the main domain 202a.

In addition to the SoC 200 discussed above, various aspects may be implemented in a wide variety of computing systems, which may include a single processor, multiple processors, multicore processors, or any combination thereof. Various aspects described herein may also be implemented in systems that employ more than one SoC. For example, a SoC-based ECU may include multiple SoCs (e.g., SoCs 200) configured to monitor the safety of a vehicle control system (e.g., vehicle control system 102). In these examples, each of the multiple SoC(s) may include different numbers of main domains and/or safety domains.

### Aspects of Safe and Secure End-to-End Autonomous Driving Systems

Aspects of the present disclosure relate to a safe and secure end-to-end AD system for a vehicle.

As noted, while certain vehicles may use end-to-end AD models (e.g., LL-E2E-MM4ADs) to realize full AD (e.g., SAE level 5), such end-to-end AD models may not be optimal (or at least suitable) for semi-AD, which may include any of the SAE levels 1 to 4. Compared to full AD, semi-AD may involve at least some human input, human attention, and/or human intervention in certain scenarios (e.g., certain vehicle operating conditions, road conditions, and/or environments). In certain cases, however, conventional end-to-end AD models may not allow (or support) human interaction when driving. Additionally, such conventional end-to-end AD models may lack the capability to communicate with a human user (e.g., driver or passenger) regarding security events and/or safety events in the environment. Due in part to these aforementioned drawbacks, certain end-to-end AD models may lack compliance with certain FuSa standards, such as ISO/PAS 8800, when deployed in vehicles that include semi-AD systems. Additionally, certain end-to-end AD models deployed in vehicles that include full-AD systems may compromise the performance of the full-AD system, since these models may not be able to interact with the human passenger for updates and/or uncertainty regarding detected safety and/or security events.

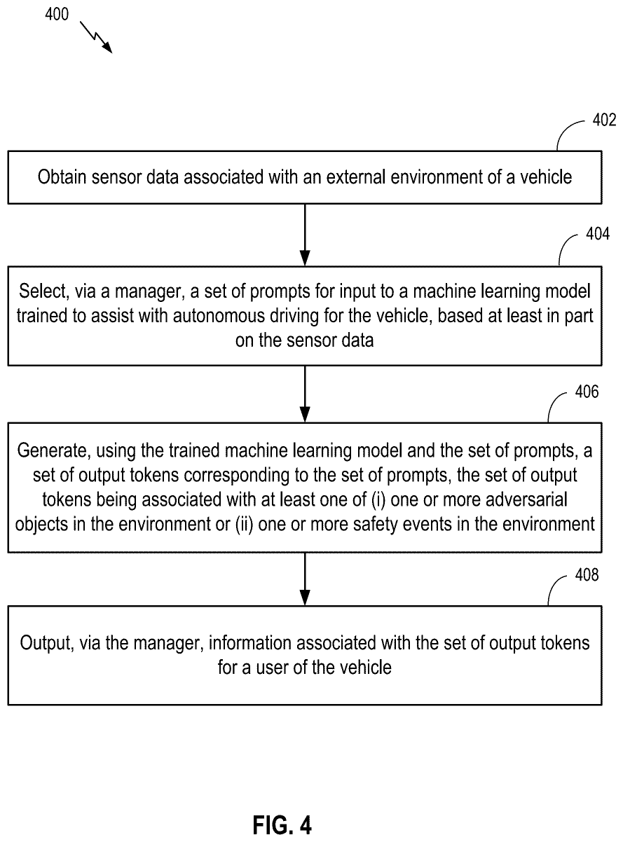

To address this, certain aspects described herein provide a safe and secure end-to-end AD system that includes a safe and secure end-to-end AD model (e.g., a safe and secure LL-E2E-MM4AD). The safe and secure end-to-end AD system described herein can be utilized in vehicles that include semi-AD systems (e.g., SAE levels 4 to 1) and/or full-AD systems (e.g., SAE level 5) and may comply with certain FuSa standards, such as ISO/PAS 8800. In certain aspects, the safe and secure end-to-end AD system described herein may include components (hardware and/or software) that can detect safety and/or security events that occur while driving. Additionally, in certain aspects, the safe and secure end-to-end AD system described herein can provide indications of safety and security events to a human driver and/or passenger (e.g., via audio, images, and/or haptics, among other modalities) in order to improve human awareness of the safety and security events. Additionally or alternatively, in certain aspects, the safe and secure end-to-end AD system described herein can allow for real-time human feedback regarding safety and security events and use the feedback to update the model. The systems and techniques described herein may be further understood with reference to FIGS. 3-4.

As used herein, a safety event may refer to an event that has a target likelihood of posing a risk to the driver, passenger, other users (e.g., pedestrians, other drivers/passengers in different vehicles), and/or property. A safety event can occur due to objects in the vehicle's external environment (e.g., road) that pose a safety risk to the vehicle due to, e.g., time to collision, intersecting trajectories, chaotic behavior, higher object class risk, such as a child, among other factors. In some cases, a safety event may refer to one or more FuSa events defined in an ISO standard, such as ISO 26262, ISO/PAS 8800, among others.

As used herein, a security event may refer to an event or attack that compromises (or at least interferes with the operation of) a vehicle's systems or sensors. A security event, for example, may involve placing adversarial objects in the vehicle's external environment to disrupt the vehicle's ability to use GPS for location tracking and route navigation, perform obstacle detection and avoidance, mislead the vehicle's location, trick the vehicle's sensors in detecting non-existent objects and/or a different number of existent objects, etc.

FIG. 3 is a block diagram of an example safe and secure end-to-end AD system 300, according to certain aspects of the present disclosure. In certain aspects, the safe and secure end-to-end AD system 300 may be included in the vehicle 100 of FIG. 1. In certain aspects, the safe and secure end-to-end AD system 300 may perform some functions of the vehicle control system 102 of the vehicle 100 described in FIG. 1. In certain aspects, the safe and secure end-to-end AD system 300 may correspond to or is associated with the SoC 200 in FIG. 2. In certain aspects, the safe and secure end-to-end AD system 300 may be used to interact with a human user 310 (e.g., driver, passenger, etc.) in a vehicle in order to provide the user 310 with information regarding safety and/or security events in the environment. In certain aspects, the safe and secure end-to-end AD system may be used in a vehicle (e.g., vehicle 100) that supports various levels of AD, such as any of SAE levels 1 to 5.

As shown, the safe and secure end-to-end AD system 300 includes a model 302 and an orchestrator 304 (also referred to as a manager, controller, or translator). The model 302 may be representative of a machine learning model, such as a deep neural network, a LLM, a LVM, a LMM, among others. In certain aspects, the model 402 is an LL-E2E-MM4AD. In the system 300, the model 302 may access sensor data 308 and/or prompts 312 to generate answers 314 related to security and/or safety events in a vehicle's external environment. For example, the answers 314 may include output tokens 324 corresponding to one or more of the prompts 312 input into the model 302. Note, in certain aspects, the prompts 312 and/or the answers 314 may be hidden from the user 310. That is, the user 310 may not have visibility to the prompts 312 that are input into the model 302 as well as the answers 314 that are output by the model 302.

The sensor data 308 may be representative of various types of sensor data, including visual data, lidar data, radar data, ultrasonic data, etc. The sensor data 308 may be obtained from any one of (or combination of) the vehicle's sensors (e.g., sensors 222). The orchestrator 304 may be configured to manage the prompts 312 as well as coordinate/interact with the user 310 to receive (and translate) user input information and/or output information associated with the prompts 312, answers 314, model 302, sensor data 308, or any combination thereof. In certain aspects, the orchestrator 304 is implemented at least in part by another machine learning model, a rules engine, or a look-up table.

As used herein, “accessing” data may generally include receiving, requesting, retrieving, obtaining, generating, collecting, to otherwise gaining access to the data. Although depicted as a discrete components for conceptual clarity, in certain aspects, the operations of the model 302 and/or the orchestrator 304 may be implemented using hardware, software, or a combination of hardware and software, and may be distributed across any number and variety of systems.

In certain aspects, the model 302 is an LL-E2E-MM4AD that can support input data in one or more (or a combination of) modalities and perform a variety of tasks. Such modalities may include visual data (e.g., images, videos, graphical representations), textual (or text) data, sensor data (e.g., lidar data, GPS data, radar data, ultrasonic data, etc.), auditory data (e.g., speech, ambient sounds, music, etc.), and/or haptic data, among other data types. The tasks may include object detection and tracking (e.g., pedestrians, other vehicles, road obstacles, etc.), mapping, motion prediction, occupancy prediction, and planning, as illustrative examples.

In certain aspects, the prompts 312 include different classes of prompts associated with safety and/or security events for the vehicle (e.g., vehicle 100). For example, the prompts 312 may include (i) a set of templates for security prompts 316 associated with adversarial objects (e.g., objects used to disrupt operations of the vehicle's systems and/or sensors) in the vehicle's external environment, (ii) a set of templates for safety prompts 318 associated with safety events in the vehicle's external environment, (iii) a set of templates for action prompts 320 associated with interacting with a driver and/or passenger of the vehicle, or (iv) any combination thereof.

The respective set of templates for the security prompts 316, safety prompts 318, and/or action prompts 320 may include placeholder fields that may be populated by the safe and secure end-to-end AD system (via the orchestrator 304) and/or a human user (via a system update). Configuring template prompts in this manner may allow the safe and secure end-to-end AD system to be flexible and process different types of safety and security events.

For example, the security prompts 316 may enable the safe and secure end-to-end AD system to detect adversarial objects of various configurations/form factors (e.g., different sizes, shapes, etc.). In certain aspects, the security prompts 316 may include single image-based security prompts (e.g., security prompts that are based on a single image in the sensor data 308). In an illustrative example, a single image-based security prompt may be expressed with “Is there an attack X in the scene?,” where X is a placeholder field that may be populated by the orchestrator 304 with a value determined based on the sensor data 308, answers 314, parameters of the model 302, and/or vehicle hardware readings, etc. In another illustrative example, a single image-based security prompt may be expressed with “Are there more than X detected objects in the scene?,” where X is a placeholder field that may be populated by the orchestrator 304 with a value determined based on the sensor data 308, answers 314, parameters of the model 302, and/or vehicle hardware readings, etc. In yet another illustrative example, a single image-based security prompt may be expressed with “Are there more than X detected objects with the classification Y in the location Z?,” where X, Y, and Z are placeholder fields that may be populated by the orchestrator 304 with respective values determined based on the sensor data 308, answers 314, parameters of the model 302, and/or vehicle hardware readings, etc.

In certain aspects, the security prompts 316 may include multiple image-based security prompts (e.g., security prompts that are based on multiple (consecutive) images in the sensor data 308). In an illustrative example, a multiple image-based security prompt may be expressed with “Have you seen more than X [objects/masks] in Y consecutive images?,” where X and Y are placeholder fields that may be populated by the orchestrator 304 with respective values determined based on the sensor data 308, answers 314, parameters of the model 302, and/or vehicle hardware readings, etc. In another illustrative example, a multiple image-based security prompt may be expressed with “Have you seen objects with different classes across Y consecutive images?,” where Y is a placeholder field that may be populated by the orchestrator 304 with a value determined based on the sensor data 308, answers 314, parameters of the model 302, and/or vehicle hardware readings, etc.

In certain aspects, the safety prompts 318 may enable the safe and secure end-to-end AD system to prevent and log safety events, such as FuSa events. Similar to the security prompts 316, the safety prompts 318 may include single image-based safety prompts (e.g., safety prompts that are based on a single image in the sensor data 308) and/or multiple image-based safety prompts (e.g., safety prompts that are based on multiple images in the sensor data 308). In an illustrative example, a single image-based safety prompt may be expressed with “Highlight objects with a safety risk,” where safety risk can be due to time to collision, intersecting trajectories, chaotic behavior, higher object class risk (e.g., child), etc. In another illustrative example, a single image-based safety prompt may be expressed with “Highlight degraded road infrastructures.” In another illustrative example, a single image-based safety prompt and/or multiple image-based safety prompt may be expressed with “Highlight image regions where it is difficult for perception,” e.g., due to glare, low contrast, low lighting, rain/snow/fog, etc. In some cases, the safety prompts 318 may be input into the model as part of a chain query. For example, a first safety prompt may ask the model to identify challenging image regions, and a second safety prompt may ask the model to identify safety risks in the challenging image regions.

In certain aspects, the action prompts 320 may enable the safe and secure end-to-end AD system to perform certain actions for specific use cases. Such actions may include enabling/disabling visualization of answers 314, enabling/disabling output of audio content that includes an audio representation of the answers 314, adjusting an amount of information associated with the answers 314 that is displayed on the vehicle's human-machine interface (HMI) (e.g., vehicle dashboard, heads-up display (HUD), smart windshield, etc.) and/or included within the audio content, reporting, and remediation for the vehicle's HMI. The use cases may include explainable artificial intelligence (AI) (XAI) and/or remediation AI (RAI).

In certain aspects, XAI may involve outputting information to the user 310 (e.g., displaying visualizations and/or outputting audio content) that may help the user 310 to understand the behavior of the model. For example, an action prompt for XAI may be expressed with “Can you display adversarial objects?”

In certain aspects, a first type of RAI may involve refraining from outputting information to the user 310 to avoid confusing and/or distracting the user 310 via the vehicle's HMI, while maintaining records of adversarial objects for accountability purposes in case of a road accident, for example. For instance, an action prompt for such a first type of RAI may be expressed with “Provide data of detected adversarial objects but do not display them in the image.”

In certain aspects, a second type of RAI may involve modifying (e.g., removing) data (e.g., location, class, confidence) associated with adversarial objects. For example, an action prompt for such a second type of RAI type may be expressed with “Remove all data of detected adversarial objects.”

In certain aspects, the orchestrator 304 may select, from the prompts 312, a set of prompts to input into the model 302. The orchestrator 304 may select a given set of prompts 312 based on at least one of (i) one or more safety and/or security policies (e.g., send a prompt every X images), (ii) one or more profiling values (e.g., interference time is above a threshold), (iii) one or more vehicle hardware readings (e.g., temperature is above a threshold), and/or (iv) model's answers (e.g., number of boxes is above a threshold).

In certain aspects, the orchestrator 304 may populate the populated fields within each of the selected set of prompts with respective values determined based on various factors. In some examples, the respective values may be determined based on geographical information for the environment (e.g., the values may be map-based). For instance, the orchestrator 304 may determine that a particular highway has a speed limit of 130 kilometers per hour (km/h). In this example, assuming the orchestrator 304 selects a prompt expressed with “Is there a speed sign with a speed limit above X km/h?,” the orchestrator 304 can replace “X” with “130” in order to generate a prompt expressed with “Is there a speed sign with a speed limit above 130 km/h?”

In some examples, the respective values may be determined based on information for the environment stored in one or more cloud-based storage locations (e.g., the values may be cloud-based). In an illustrative example, the cloud-based storage locations can provide an indication of the number of cars on the road.

In some examples, the respective values may be determined based on one or more preconfigured values (e.g., the values may be hard-coded). In an illustrative example, the orchestrator 304 may determine, from the hard-coded values, that a temperature should not exceed a certain value.

As noted, in certain aspects, the prompts 312 and/or the answers 314 may be hidden from the user 310. However, in certain aspects, the orchestrator 304 may determine to output an indication of at least one of the prompts 312 and/or the answers 314 to the user 310. In such aspects, the orchestrator 304 may act as a link (or interface) between the user 310 and the model 302. For example, in some cases, the orchestrator 304 may generate an audio representation of the prompt 312 (using a text-to-audio converter) and output audio content including the audio representation in the vehicle. In other cases, the orchestrator 304 may display the prompt 312 on the vehicle's HMI (e.g., smart windshield). Additionally or alternatively, the orchestrator 304 may receive input or feedback from the user 310 and translate the input or feedback into a prompt 312 for the model 302. Such input or feedback may be in the form of text, audio, haptic data, etc., or a combination thereof.

In certain aspects, the safe and secure end-to-end AD system 300 may allow a user 310 to interact with the model 302 regarding the model's behavior and operation. In some aspects, the user 310 may interact with the model 302 to reinforce the model's answers 314. For example, the model 302 may ask the user 310 questions (via the orchestrator 304) when the model is uncertain regarding a safety and/or security event. For instance, in an adversarial object scenario, the model 302 may detect an object on the road with a borderline confidence. In this instance, the model 302 (via the orchestrator 304) may ask the user 310 “Is there an object on the road?” In response to the question, the user 310 may provide an answer to the orchestrator 304, which may translate the answer into a prompt 312 for input into the model 302.

Similarly, in certain aspects, the user 310 may interact with the model 302 via the orchestrator 304 to ask questions regarding the model's behavior. For example, in an adversarial object scenario, the model 302 may detect an object on the road with a borderline confidence and, in response, stop the vehicle. In this scenario, the user 310 may ask the model 302 (via the orchestrator 304) “Why have you stopped the car?” The orchestrator 304 may translate the user's question into a prompt for input into the model 302 and provide an answer to the user's question to the user 310 via the orchestrator 304.

Note, the questions and answers exchanged between the user 310 and the model 302 via the orchestrator 304 may have various levels of detail. For instance, the orchestrator 304 may allow the user 310 or the model 302 to ask, “Is there a [red] [car] on the [right side] of the road?” Such level of detail may help the user 310 and/or the model 302 to identity an object in the scene.

FIG. 4 shows an example of operations or a method 400 for autonomous driving, in accordance with certain aspects of the present disclosure. The method 400 may be performed by the safe and secure end-to-end AD system 300, as described herein with respect to FIG. 3.

The method 400 begins at 402 with obtaining sensor data (e.g., sensor data 308) associated with an external environment of a vehicle (e.g., vehicle 100).

The method 400 then proceeds to 404 with selecting, via a manager (e.g., orchestrator 304), a set of prompts (e.g., prompts 312) for input to a machine learning model (e.g., model 302) trained to assist with autonomous driving for the vehicle, based at least in part on the sensor data.

The method 400 then proceeds to 406 with generating, using the trained machine learning model and the set of prompts, a set of output tokens (e.g., output tokens 324) corresponding to the set of prompts, the set of output tokens being associated with at least one of (i) one or more adversarial objects in the environment or (ii) one or more safety events in the environment.

The method 400 then proceeds to 408 with outputting, via the manager, information associated with the set of output tokens for a user of the vehicle.

In certain aspects, the set of prompts includes one or more security prompts (e.g., security prompts 316) associated with the one or more adversarial objects in the environment.

In certain aspects, the set of prompts includes one or more safety prompts (e.g., safety prompts 318) associated with the one or more safety events in the environment.

In certain aspects, the set of prompts includes one or more action prompts (e.g., action prompts 320) for modifying at least one of (i) a user interface of the vehicle or (ii) audio content configured to be output in the vehicle.

In certain aspects, the one or more action prompts may include a prompt for enabling at least one of (i) a visualization of the information associated with the set of output tokens on the user interface or (ii) an audio representation of the information associated with the set of output tokens within the audio content.

In certain aspects, the one or more action prompts may include a prompt for disabling at least one of (i) a visualization of the information associated with the set of output tokens on the user interface or (ii) an audio representation of the information associated with the set of output tokens within the audio content.

In certain aspects, the one or more action prompts may include a prompt for adjusting at least one of (i) an amount of the information associated with the set of output tokens displayed on the user interface or (ii) an amount of the information associated with the set of output tokens within the audio content.

In certain aspects, the sensor data may include image data, and the set of prompts may be selected based on (i) a single image within the image data or (ii) a plurality of images within the image data.

In certain aspects, the set of prompts may be selected based on (i) an amount of the sensor data, (ii) an inference time of the trained machine learning model, (iii) one or more hardware metrics for the vehicle, (iv) output of the trained machine learning model, or (v) any combination thereof.

In certain aspects, selecting the set of prompts may involve: identifying a set of template prompts from a plurality of template prompts, based on the sensor data, each template prompt of the set of template prompts comprising one or more placeholder fields; for each template prompt of the set of template prompts, populating the one or more placeholders fields with one or more respective values determined based at least in part on the sensor data; and using the set of template prompts with the populated placeholder fields as the selected set of prompts. In these aspects, for each template prompt of the set of template prompts, the one or more respective values may be determined based on (i) geographical information for the environment, (ii) information for the environment stored in one or more cloud-based storage locations, (iii) one or more preconfigured values, or (iv) any combination thereof.

In certain aspects, the method 400 further includes outputting, via the manager, an indication of the set of prompts for the user of the vehicle. In some aspects, outputting the indication of the set of prompts may involve: converting text of the set of prompts to speech via a text-to-speech model; and outputting audio corresponding to the converted text of the set of prompts. In some aspects, outputting the indication of the set of prompts may involve displaying the set of prompts on a user interface of the vehicle.

In certain aspects, the method 400 further includes receiving, via the manager, feedback from the user regarding the set of prompts, the information associated with the output tokens, or any combination thereof.

In certain aspects, the trained machine learning model is a trained large multimodal, end-to-end, autonomous driving model.

In certain aspects, the manager is implemented at least in part by another machine learning model or a look-up table.

The various operations of methods described above may be performed by any suitable means capable of performing the corresponding functions. The means may include various hardware and/or software component(s) and/or module(s), including, but not limited to a circuit, an application specific integrated circuit (ASIC), or a processor.

### Example Clauses

Implementation examples are described in the following numbered clauses:
Clause 1: A processor-implemented method for autonomous driving, the processor-implemented method comprising: obtaining sensor data associated with an external environment of a vehicle; selecting, via a manager, a set of prompts for input to a machine learning model trained to assist with autonomous driving for the vehicle, based at least in part on the sensor data; generating, using the trained machine learning model and the set of prompts, a set of output tokens corresponding to the set of prompts, the set of output tokens being associated with at least one of (i) one or more adversarial objects in the environment or (ii) one or more safety events in the environment; and outputting, via the manager, information associated with the set of output tokens for a user of the vehicle.
Clause 2: The processor-implemented method of Clause 1, wherein the set of prompts comprises one or more security prompts associated with the one or more adversarial objects in the environment.
Clause 3: The processor-implemented method in accordance with any of Clauses 1-2, wherein the set of prompts comprises one or more safety prompts associated with the one or more safety events in the environment.
Clause 4: The processor-implemented method in accordance with any of Clauses 1-3, wherein the set of prompts comprises one or more action prompts for modifying at least one of (i) a user interface of the vehicle or (ii) audio content configured to be output in the vehicle.
Clause 5: The processor-implemented method of Clause 4, wherein the one or more action prompts comprise a prompt for enabling at least one of (i) a visualization of the information associated with the set of output tokens on the user interface or (ii) an audio representation of the information associated with the set of output tokens within the audio content.
Clause 6: The processor-implemented method in accordance with any of Clauses 4-5, wherein the one or more action prompts comprise a prompt for disabling at least one of (i) a visualization of the information associated with the set of output tokens on the user interface or (ii) an audio representation of the information associated with the set of output tokens within the audio content.
Clause 7: The processor-implemented method in accordance with any of Clauses 4-6, wherein the one or more action prompts comprise a prompt for adjusting at least one of (i) an amount of the information associated with the set of output tokens displayed on the user interface or (ii) an amount of the information associated with the set of output tokens within the audio content.
Clause 8: The processor-implemented method in accordance with any of Clauses 1-7, wherein: the sensor data comprises image data; and the set of prompts is selected based on (i) a single image within the image data or (ii) a plurality of images within the image data.
Clause 9: The processor-implemented method in accordance with any of Clauses 1-8, wherein the set of prompts is selected based on (i) an amount of the sensor data, (ii) an inference time of the trained machine learning model, (iii) one or more hardware metrics for the vehicle, (iv) output of the trained machine learning model, or (v) any combination thereof.
Clause 10: The processor-implemented method in accordance with any of Clauses 1-9, wherein selecting the set of prompts comprises: identifying a set of template prompts from a plurality of template prompts, based on the sensor data, each template prompt of the set of template prompts comprising one or more placeholder fields; for each template prompt of the set of template prompts, populating the one or more placeholders fields with one or more respective values determined based at least in part on the sensor data; and using the set of template prompts with the populated placeholder fields as the selected set of prompts.
Clause 11: The processor-implemented method of Clause 10, wherein, for each template prompt of the set of template prompts, the one or more respective values are determined based on (i) geographical information for the environment, (ii) information for the environment stored in one or more cloud-based storage locations, (iii) one or more preconfigured values, or (iv) any combination thereof.
Clause 12: The processor-implemented method in accordance with any of Clauses 1-11, further comprising outputting, via the manager, an indication of the set of prompts for the user of the vehicle.
Clause 13: The processor-implemented method of Clause 12, wherein outputting the indication of the set of prompts comprises: converting text of the set of prompts to speech via a text-to-speech model; and outputting audio corresponding to the converted text of the set of prompts.
Clause 14: The processor-implemented method in accordance with any of Clauses 12-13, wherein outputting the indication of the set of prompts comprises displaying the set of prompts on a user interface of the vehicle.
Clause 15: The processor-implemented method in accordance with any of Clauses 1-14, further comprising receiving, via the manager, feedback from the user regarding the set of prompts, the information associated with the output tokens, or any combination thereof.
Clause 16: The processor-implemented method in accordance with any of Clauses 1-15, wherein the trained machine learning model is a trained large multimodal, end-to-end, autonomous driving model.
Clause 17: The processor-implemented method in accordance with any of Clauses 1-16, wherein the manager is implemented at least in part by another machine learning model or a look-up table.
Clause 18: A processing system comprising: a memory comprising processor-executable instructions; and one or more processors coupled to the one or more memories and configured to execute the processor-executable instructions and cause the processing system to perform a method in accordance with any of Clauses 1-17.
Clause 19: A vehicle comprising the processing system of Clause 18.
Clause 20: A processing system comprising means for performing a method in accordance with any of Clauses 1-17.
Clause 21: A non-transitory computer-readable medium comprising computer-executable instructions that, when executed by one or more processors of a processing system, cause the processing system to perform a method in accordance with any of Clauses 1-17.
Clause 22: A computer program product embodied on a computer-readable storage medium comprising code for performing a method in accordance with any of Clauses 1-17.

### Additional Considerations

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. A processing system for autonomous driving, comprising:
one or more memories comprising processor-executable instructions; and
one or more processors coupled to the one or more memories and configured to execute the processor-executable instructions and cause the processing system to:
obtain sensor data associated with an external environment of a vehicle;
select, via a manager, a set of prompts for input to a machine learning model trained to assist with autonomous driving for the vehicle, based at least in part on the sensor data and on at least one of (i) an inference time of the trained machine learning model or (ii) one or more hardware metrics for the vehicle;
generate, using the trained machine learning model and the set of prompts, a set of output tokens corresponding to the set of prompts, the set of output tokens being associated with at least one of (i) one or more adversarial objects in the environment or (ii) one or more safety events in the environment;
output, via the manager, information associated with the set of output tokens for a user of the vehicle;
receive, via the manager, feedback from the user regarding the information associated with the set of output tokens;
translate, via the manager, the feedback into an additional prompt for input to the trained machine learning model; and
generate, using the trained machine learning model and the additional prompt, an additional set of output tokens.

2. The processing system of claim 1, wherein the set of prompts comprises one or more security prompts associated with the one or more adversarial objects in the environment, the one or more adversarial objects comprising one or more objects configured to disrupt operation of at least one of (i) one or more systems of the vehicle or (ii) one or more sensors of the vehicle.

3. The processing system of claim 1, wherein the set of prompts comprises one or more safety prompts associated with the one or more safety events in the environment.

4. The processing system of claim 1, wherein the set of prompts comprises one or more action prompts for modifying at least one of (i) a user interface of the vehicle or (ii) audio content configured to be output in the vehicle.

5. The processing system of claim 4, wherein the one or more action prompts comprise a prompt for enabling at least one of (i) a visualization of the information associated with the set of output tokens on the user interface or (ii) an audio representation of the information associated with the set of output tokens within the audio content.

6. The processing system of claim 4, wherein the one or more action prompts comprise a prompt for disabling at least one of (i) a visualization of the information associated with the set of output tokens on the user interface or (ii) an audio representation of the information associated with the set of output tokens within the audio content.

7. The processing system of claim 4, wherein the one or more action prompts comprise a prompt for adjusting at least one of (i) an amount of the information associated with the set of output tokens displayed on the user interface or (ii) an amount of the information associated with the set of output tokens within the audio content.

8. The processing system of claim 1, wherein:
the sensor data comprises image data; and
the set of prompts is selected based on (i) a single image within the image data or (ii) a plurality of images within the image data.

9. The processing system of claim 1, wherein the set of prompts is further selected based on (i) an amount of the sensor data, (ii) output of the trained machine learning model, or (iii) any combination thereof.

10. The processing system of claim 1, wherein to select the set of prompts, the one or more processors are configured to execute the processor-executable instructions and cause the processing system to:
identify a set of template prompts from a plurality of template prompts, based on the sensor data, each template prompt of the set of template prompts comprising one or more placeholder fields;
for each template prompt of the set of template prompts, populate the one or more placeholder fields with one or more respective values determined based at least in part on the sensor data; and
use the set of template prompts with the populated placeholder fields as the selected set of prompts.

11. The processing system of claim 10, wherein, for each template prompt of the set of template prompts, the one or more respective values are determined based on (i) geographical information for the environment, (ii) information for the environment stored in one or more cloud-based storage locations, (iii) one or more preconfigured values, or (iv) any combination thereof.

12. The processing system of claim 1, wherein the one or more processors are further configured to execute the processor-executable instructions and cause the processing system to output, via the manager, an indication of the set of prompts for the user of the vehicle.

13. The processing system of claim 12, wherein to output the indication of the set of prompts, the one or more processors are configured to execute the processor-executable instructions and cause the processing system to:
convert text of the set of prompts to speech via a text-to-speech model; and
output audio corresponding to the converted text of the set of prompts.

14. The processing system of claim 12, wherein to output the indication of the set of prompts, the one or more processors are configured to execute the processor-executable instructions and cause the processing system to display the set of prompts on a user interface of the vehicle.

15. The processing system of claim 1, wherein the one or more processors are further configured to execute the processor-executable instructions and cause the processing system to update the trained machine learning model based at least in part on the feedback.

16. The processing system of claim 1, wherein the trained machine learning model is a trained large multimodal, end-to-end, autonomous driving model.

17. The processing system of claim 1, wherein the manager is implemented at least in part by another machine learning model or a look-up table.

18. A processor-implemented method for autonomous driving, the processor-implemented method comprising:
obtaining sensor data associated with an external environment of a vehicle;
selecting, via a manager, a set of prompts for input to a machine learning model trained to assist with autonomous driving for the vehicle, based at least in part on the sensor data and on at least one of (i) an inference time of the trained machine learning model or (ii) one or more hardware metrics for the vehicle;
generating, using the trained machine learning model and the set of prompts, a set of output tokens corresponding to the set of prompts, the set of output tokens being associated with at least one of (i) one or more adversarial objects in the environment or (ii) one or more safety events in the environment;
outputting, via the manager, information associated with the set of output tokens for a user of the vehicle;
receiving, via the manager, feedback from the user regarding the information associated with the set of output tokens;
translating, via the manager, the feedback into an additional prompt for input to the trained machine learning model; and
generating, using the trained machine learning model and the additional prompt, an additional set of output tokens.

19. The processor-implemented method of claim 18, wherein the set of prompts comprises: (i) one or more security prompts associated with the one or more adversarial objects in the environment; (ii) one or more safety prompts associated with the one or more safety events in the environment; (iii) one or more action prompts for modifying at least one of a user interface of the vehicle or audio content configured to be output in the vehicle; or (iv) any combination thereof.

20. A processing system comprising:
means for obtaining sensor data associated with an external environment of a vehicle;
means for selecting, via a manager, a set of prompts for input to a machine learning model trained to assist with autonomous driving for the vehicle, based at least in part on the sensor data and on at least one of (i) an inference time of the trained machine learning model or (ii) one or more hardware metrics for the vehicle;
means for generating, using the trained machine learning model and the set of prompts, a set of output tokens corresponding to the set of prompts, the set of output tokens being associated with at least one of (i) one or more adversarial objects in the environment or (ii) one or more safety events in the environment;
means for outputting, via the manager, information associated with the set of output tokens for a user of the vehicle;
means for receiving, via the manager, feedback from the user regarding the information associated with the set of output tokens;
means for translating, via the manager, the feedback into an additional prompt for input to the trained machine learning model; and
means for generating, using the trained machine learning model and the additional prompt. an additional set of output tokens.
